(19) United States
(12) Patent Application Publication
(10) Pub. No.: US 2007/0251832 A1
(43) Pub. Date: Nov. 1, 2007

(54) Method and apparatus for electrochemical mechanical polishing of cu with higher liner velocity for better surface finish and higher removal rate during clearance

(75) Inventors: Tianbao Du, Santa Clara, CA (US); Feng Q. Liu, San Jose, CA (US); You Wang, Cupertino, CA (US); Alain Duboust, Sunnyvale, CA (US); Wei-Yung Hsu, Santa Clara, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/413,493

(22) Filed: Apr. 27, 2006

(51) Int. Cl. B23H 9/00

(52) U.S. Cl. 205/640

(57) ABSTRACT

The present invention relates to an apparatus and a method for polishing a semiconductor substrate with high throughput. One embodiment of the present invention provides an apparatus for electro-chemical mechanical polishing a conductive surface on a substrate. The apparatus comprises a fluid basin having a fluid volume for retaining a polishing solution, a linear polishing station disposed in the fluid basin, wherein the linear polishing station having at least one electrode and a conductive top surface with a linear movement, the conductive top surface is configured to provide an electrical bias to the conductive surface on the substrate, and a carrier head configured to retain the substrate and position the conductive surface of the substrate to be in contact with the conductive top surface of the linear polishing station.

### BACKGROUND OF THE INVENTION

1. Field of the Invention

Embodiments of the invention generally relate to an apparatus and method for polishing or planarization of semiconductor substrates.

2. Description of the Related Art

Sub-micron multi-level metallization is one of the key technologies for the next generation of ultra large-scale integration (ULSI). The multilevel interconnects that lie at the heart of this technology require planarization of interconnect features formed in high aspect ratio apertures, including contacts, vias, trenches and other features. Reliable formation of these interconnect features is very important to the success of ULSI and to the continued effort to increase circuit density and quality on individual substrates and die.

In the fabrication of integrated circuits and other electronic devices, multiple layers of conducting, semiconducting, and dielectric materials are deposited on or removed from a surface of a substrate. Thin layers of conducting, semiconducting, and dielectric materials may be deposited by a number of deposition techniques. Common deposition techniques in modern processing include physical vapor deposition (PVD), also known as sputtering, chemical vapor deposition (CVD), plasma-enhanced chemical vapor deposition (PECVD), and electro-chemical plating (ECP).

As layers of materials are sequentially deposited and removed, the uppermost surface of the substrate may become non-planar across its surface and require planarization. An example of non-planar process is the deposition of copper films with the ECP process in which the copper topography simply follows the already existing non-planar topography of the wafer surface, especially for lines wider than 10 microns. Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Planarization is generally performed using Chemical Mechanical Polishing (CMP). As shown in FIG. 1, a planarization method typically requires that a substrate 101 be mounted in a carrier head 110, with the surface to be polished exposed. The substrate 101 supported by the carrier head 110 is then placed against a rotating polishing pad 121 supported by a platen 122. The carrier head 110 holding the substrate 101 may also rotate to provide additional motion between the substrate 101 and the polishing pad 121 and apply a down force between the substrate 101 and the polishing pad 121 to generate friction. Further, a polishing solution 103 is supplied to the polishing pad 121 to provide an abrasive chemical solution at the interface between the polishing pad 121 and the substrate 101.

The trend of shrinking integrated circuits for increased logic density and improved chip performance leads to the use of copper and low-k dielectric materials for interconnects in chip manufacturing. However, the integration of low-k dielectric materials in the metallization structures creates some challenges to the planarization process. In one aspect, due to the reduced modulus and cohesive strength, only very low down force may be used during the CMP process, resulting in very low removal rate. An Electrochemical Mechanical Polishing (ECMP), in which an electrical bias is applied to the substrate during polishing, may be used to compensate the low removal rate at very low down force. A removal process are generally performed in at least two steps. First a bulk removal step with an aggressive polishing solution may be performed to remove the majority of the excess metal. Then a residue removal or clearance using a gentle polishing solution may be performed to completely remove the metal layer. This two step method avoids dishing. Sometimes, a third removal step, generally a CMP process, may be performed to remove the barrier layer. However, the removal current of ECMP drops quickly as resistance of the metal structures increases with the thickness of the metal structure reduces. It usually requires a long over-polishing time to remove residues and significantly reduces throughput. The challenge to remove residues becomes more pronounced as the feature size drops below 0.1 μm. Another factor that contributes to the long over-polishing time is the limitation of the rotating speed of the platen 122. At high rotating speed, the polishing solution on the polishing pad 121 will “fly” outwards due to centrifugal effects and the polishing pad 121 will dry up.

Therefore, there is a need for a polishing apparatus which enables a polishing process with an increased polishing rate.

### SUMMARY OF THE INVENTION

The present invention provides methods and apparatus for polishing a semiconductor substrate.

One embodiment of the present invention provides an apparatus for electro-chemical mechanical polishing a conductive surface on a substrate. The apparatus comprises a fluid basin having a fluid volume for retaining a polishing solution, a linear polishing station disposed in the fluid basin, wherein the linear polishing station having at least one electrode and a conductive top surface with a linear movement, the conductive top surface is configured to provide an electrical bias to the conductive surface on the substrate, and a carrier head configured to retain the substrate and position the conductive surface of the substrate to be in contact with the conductive top surface of the linear polishing station.

Another embodiment of the present invention provides an apparatus for electrochemical mechanical polishing a conductive surface of a semiconductor substrate. The apparatus comprises a fluid basin configured to retain a polishing solution, a pair of rollers disposed in the fluid basin, a polishing belt looping around the pair of rollers configured to drive the polishing belt linearly, at least one electrode supported by a platen disposed between the pair of rollers, and a carrier head configured to retain the substrate and position the conductive surface of the substrate to be in contact with the polishing belt.

Yet another embodiment of the present invention comprises a method for electrochemical mechanical polishing a conductive surface on a substrate. The method comprises mounting a polishing belt on a pair of rollers disposed in a fluid basin containing a polishing solution, wetting the polishing belt while moving the polishing belt linearly by rotating the pair of rollers, and contacting the conductive surface on the substrate with the polishing belt to apply a first bias between the substrate and a first electrode supported by a platen disposed between the pair of rollers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a state of art electrochemical polishing system.

FIG. 2 schematically illustrates a sectional view of an electrochemical mechanical polishing system in accordance with one embodiment of the present invention.

FIG. 3A illustrates a perspective view of a part of an electrochemical mechanical polishing system in accordance with one embodiment of the present invention.

FIG. 3B illustrates a sectional view of the electrochemical mechanical polishing system shown in FIG. 3A.

FIG. 4A illustrates a perspective view of a part of an electrochemical mechanical polishing system in accordance with one embodiment of the present invention.

FIG. 4B illustrates a sectional view of the electrochemical mechanical polishing system shown in FIG. 4A.

FIG. 5A illustrates a perspective view of a part of an electrochemical mechanical polishing system in accordance with one embodiment of the present invention.

FIG. 5B illustrates a sectional view of the electrochemical mechanical polishing system shown in FIG. 5A.

FIG. 6 illustrates a top view of an electrode used in electrochemical mechanical polishing systems of the present invention.

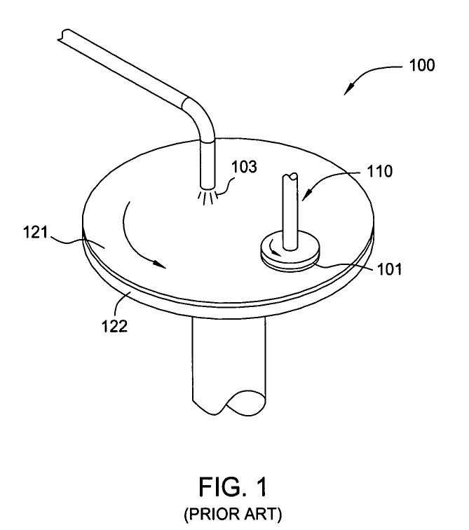

### DETAILED DESCRIPTION

The present invention provides methods and apparatus for polishing semiconductor substrates in a high throughput.

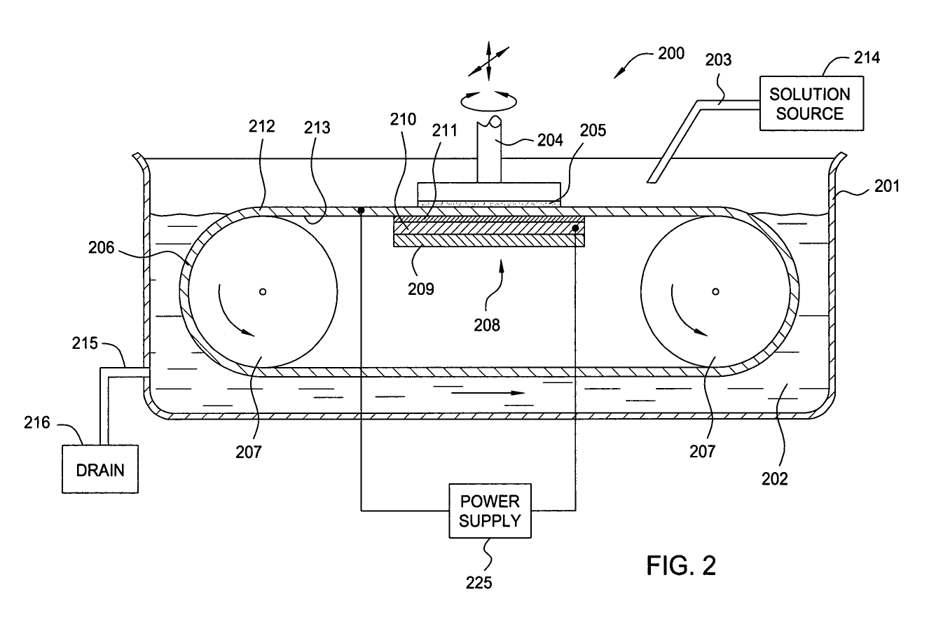

FIG. 2 schematically illustrates a sectional view of an electrochemical mechanical polishing system 200 in accordance with one embodiment of the present invention. The electrochemical mechanical polishing system 200 comprises a fluid basin 201 configured to retain a polishing solution 202 therein. Two rollers 207 are disposed in the fluid basin 201. A polishing belt 206 is looped around the rollers 207 such that rotation of the rollers 207 enables a linear movement of the polishing belt 206. The polishing belt 206 comprises a belt of material compatible with the fluid environment and the processing specifications. In one embodiment, the polishing belt 206 comprises at least a partially conductive upper surface 212. The upper surface 212 may comprise a conductive material, such as one or more conductive elements, or a conductive fabric, or a conductive polishing material for providing an electric bias to a substrate 205 during process. The polishing belt 206 is generally porous or containing a plurality of perforations to allow the polishing solution to flow through. The construction of the polishing belt 206 may be similar to any of the conductive polishing pads described in U.S. Pat. No. 6,962,524, entitled “Conductive Polishing Article for Electrochemical Mechanical Polishing”, which is incorporated herein as reference.

A platen 208 is disposed between the rollers 207 with a top surface of the platen 208 in contact with a bottom surface 213 of the polishing belt 206. The platen 208 generally supports the polishing belt 206 providing a rigid polishing surface for the substrate 205. In one embodiment, the platen 208 may comprise a base 209 for supporting an electrode assembly 210 and a support portion 211 on the electrode assembly 210. The support portion 211 may be made of dielectric material and contain a plurality of perforations to provide paths for the polishing solution 202 from the substrate 205 to the electrode assembly 210 during process. In one embodiment, the electrode assembly 210 may comprise several electrodes to create different zones during polishing. The structure of the platen 208 may be similar to any of the platens described in U.S. Pat. No. 6,962,524, entitled “Conductive Polishing Article for Electrochemical Mechanical Polishing”, which is incorporated herein as reference.

A power supply 225 is adapted between the polishing belt 206 and the electrode assembly 210 to provide a polishing bias during an electrochemical mechanical polishing process. A supply pipe 203 connected to a solution source 214 is configured to provide the polishing solution 202 to the polishing belt 206 and the fluid basin 201 and/or to wet the polishing belt 206 at the beginning of a polishing process. A drain pipe 215 connected to a solution drain 216 may be adapted to the fluid basin 201 to maintain a desired solution level.

A carrier head 204 configured to retain the substrate 205 is positioned above the polishing belt 206. The carrier head 204 may move vertically to position the substrate 205 to be in contact with the polishing belt 206 and to rotate the substrate 205 during polishing. In one embodiment, the carrier head 204 may apply a down force to the substrate 205 to assist the polishing process. In another embodiment, the carrier head 204 may be positioned such that a zero down force is applied to the substrate 205 during the polishing process. Detailed description of the carrier head 204 may be found in U.S. Pat. No. 6,183,354, entitled “Carrier Head with Flexible Membrane for Chemical Mechanical Polishing”, and U.S. patent application Ser. No. 11/054,128, filed on Feb. 8, 2005, entitled “Multiple-Chamber Carrier Head with a Flexible Membrane”, which are incorporated herein by reference.

During processing, the two rollers 207 rotate simultaneously driving the polishing belt 206 at a linear speed. The polishing solution 202 generally maintains at a level that is slightly lower than the highest point of the polishing belt 206 such that the polishing belt 206 other than the top portion is “soaked” in the polishing solution 202. The polishing solution 202 may be “carried” to the polishing position on the top portion. Additionally, the supply pipe 203 may provide extra polishing solution to the top portion of the polishing belt 206 when needed. The platen 208 is positioned to be in contact with the polishing belt 206 and provide a solid support for the polishing belt 206 on the top portion. The platen 208 may have a planar, or non-planar top surface to achieve a uniform polishing rate across the substrate 205. A polishing bias is generally applied to by the power supply 225 between the polishing belt 206 and the electrode assembly 210. The polishing solution in the polishing belt 206 and the support portion 211 provides an electrical path between the polishing belt 206 and the electrode assembly 210. The carrier head 204 generally retains the substrate 205 with a surface to be polished facing the linear moving polishing belt 206. The carrier head 204 may rotate and lower to position the substrate 205 to be in contact with the upper surface 212 of the polishing belt 206. The polishing bias is now applied between the substrate 205 and the electrode assembly 210 to enable an electrochemical mechanical polishing. The rotation of the substrate 205 and the linear movement of the polishing belt 206 contribute to a relative motion between the substrate 205 and the polishing belt 206 for a uniform polishing and generate friction for mechanical polishing. In one embodiment, especially when the width of the polishing belt 206 is smaller than the diameter of the substrate 205, a sweeping motion may be performed by the carrier head 204 to achieve uniform polishing rate across the substrate 205. The linear motion of the polishing belt 206 may be much faster than a rotating polishing pad since the linear motion will not dry out the polishing belt 206. This configuration may be used for bulk polishing, residue removal or buffing stage of a planarization process.

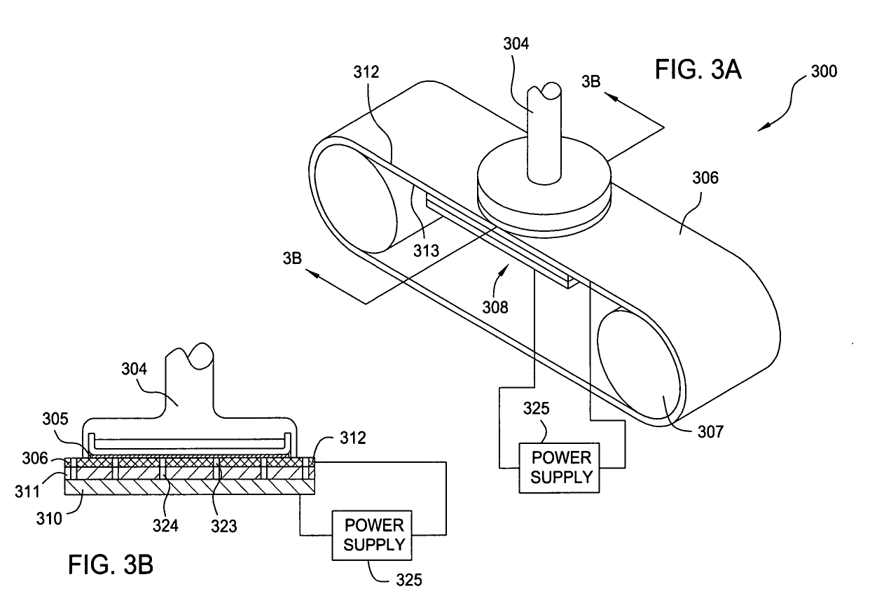

FIG. 3A illustrates a perspective view of a part of an electrochemical mechanical polishing system 300 in accordance with one embodiment of the present invention. FIG. 3B illustrates a sectional view of the electrochemical mechanical polishing system 300 shown in FIG. 3A.

Similar to the electrochemical mechanical polishing system 200 shown in FIG. 2, the electrochemical mechanical polishing system 300 comprises a fluid basin (omitted to expose structures inside the fluid basin) configured to retain a polishing solution. Two rollers 307 are disposed in the fluid basin. A polishing belt 306 is looped around the rollers 307 such that rotation of the rollers 307 enables a linear movement of the polishing belt 306. The polishing belt 306 comprises a belt of material compatible with the fluid environment and the processing specifications. In one embodiment, the polishing belt 306 comprises a conductive upper surface 312 manufactured from a conductive material, such as a conductive fabric, or a conductive polishing material for providing an electric bias to a substrate 305 during process. The polishing belt 306 contains a plurality of perforations 323 to allow the polishing solution to flow through.

A platen 308 is disposed between the rollers 307 with the top surface of the platen 308 in contact with a bottom surface 313 of the polishing belt 306. The platen 308 generally supports the polishing belt 306 providing a rigid polishing surface for the substrate 305. The platen 308 comprises an electrode assembly 310 and a support portion 311 disposed on the electrode assembly 310. The support portion 311 may be made of dielectric material and contain a plurality of perforations 324 to provide paths for the polishing solution from the substrate 305 to the electrode assembly 310 during process. In one embodiment, the perforations 324 on the support portion 311 are aligned with the perforations 323 on the polishing belt 306.

A power supply 325 is adapted between the polishing belt 306 and the electrode assembly 310 to provide a polishing bias during an electrochemical mechanical polishing process. A carrier head 304 configured to retain the substrate 305 is positioned above the polishing belt 306. The carrier head 304 may move vertically to position the substrate 305 to be in contact with the polishing belt 306 and to rotate the substrate 305 during polishing. In one embodiment, the carrier head 304 may apply a down force to the substrate 305 to assist the polishing process. In another embodiment, the carrier head 304 may be positioned such that zero down force is applied to the substrate 305 during the polishing process.

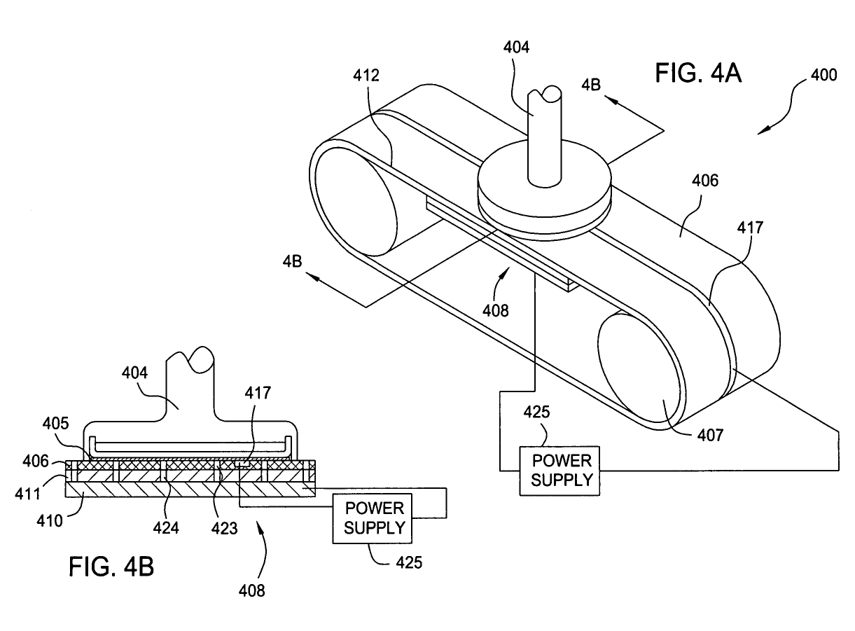

FIG. 4A illustrates a perspective view of a part of an electrochemical mechanical polishing system 400 in accordance with one embodiment of the present invention. FIG. 4B illustrates a sectional view of the electrochemical mechanical polishing 400 system shown in FIG. 4A.

Similar to the electrochemical mechanical polishing system 200 shown in FIG. 2, the electrochemical mechanical polishing system 400 comprises a fluid basin (omitted to expose structures inside the fluid basin) configured to retain a polishing solution. Two rollers 407 are disposed in the fluid basin. A polishing belt 406 is looped around the rollers 407 such that rotation of the rollers 407 enables a linear movement of the polishing belt 406. The polishing belt 406 comprises a belt of material compatible with the fluid environment and the processing specifications. The polishing belt 406 comprises one or more conductive strips 417 on an upper surface 412. The one or more conductive strips 417 may be manufactured from a conductive material, such as a conductive fabric, one or more conductive element, or a conductive polishing material for providing an electric bias to a substrate 405 during process. The polishing belt 406 contains a plurality of perforations 423 to allow the polishing solution to flow through.

A platen 408 is disposed between the rollers 407 with the top surface of the platen 408 in contact with a bottom surface 413 of the polishing belt 406. The platen 408 generally supports the polishing belt 406 providing a rigid polishing surface for the substrate 405. The platen 408 comprises an electrode assembly 410 and a support portion 411 disposed on the electrode assembly 410. The support portion 411 may be made of dielectric material and contain a plurality of perforations 424 to provide paths for the polishing solution from the substrate 405 to the electrode assembly 410 during process. In one embodiment, the perforations 424 on the support portion 411 are aligned with the perforations 423 on the polishing belt 406.

A power supply 425 is adapted between the one or more conductive strips 417 on the polishing belt 406 and the electrode assembly 410 to provide a polishing bias during an electrochemical mechanical polishing process. A carrier head 404 configured to retain the substrate 405 is positioned above the polishing belt 406. The carrier head 404 may move vertically to position the substrate 405 to be in contact with the polishing belt 406 and the one or more conductive strips 417 and to rotate the substrate 405 during polishing. In one embodiment, the carrier head 404 may apply a down force to the substrate 405 to assist the polishing process. In another embodiment, the carrier head 404 may be positioned such that zero down force is applied to the substrate 405 during the polishing process.

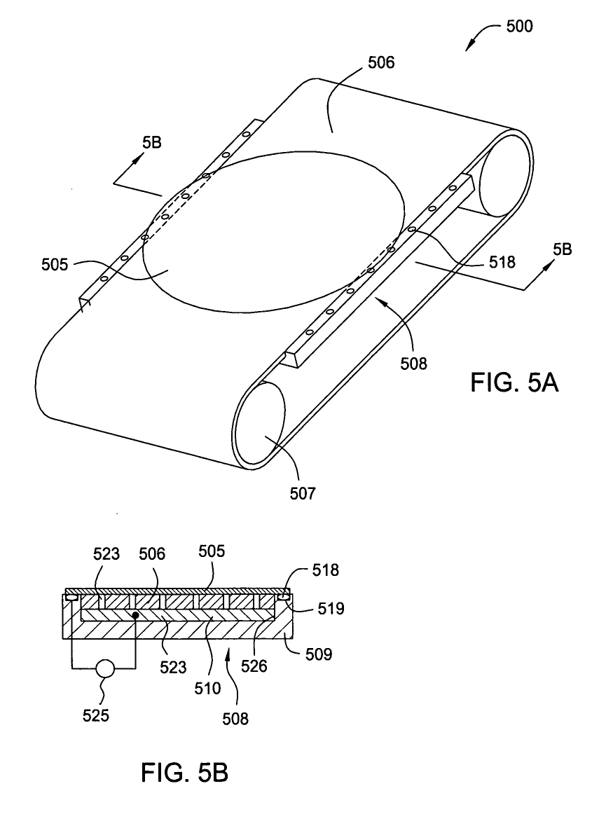

FIG. 5A illustrates a perspective view of a part of an electrochemical mechanical polishing system 500 in accordance with one embodiment of the present invention. FIG. 5B illustrates a sectional view of the electrochemical mechanical polishing system 500 shown in FIG. 5A.

Similar to the electrochemical mechanical polishing system 200 shown in FIG. 2, the electrochemical mechanical polishing system 500 comprises a fluid basin (omitted to expose structures inside the fluid basin) configured to retain a polishing solution. Two rollers 507 are disposed in the fluid basin. A polishing belt 506 is looped around the rollers 507 such that rotation of the rollers 507 enables a linear movement of the polishing belt 506. The polishing belt 506 comprises a belt of material compatible with the fluid environment and the processing specifications. In one embodiment, the polishing belt 506 having a non-conductive upper surface 512.

A platen 508 is disposed between the rollers 507 with the top surface of the platen 508 in contact with a bottom surface 513 of the polishing belt 506. The platen 508 generally supports the polishing belt 506 providing a rigid polishing surface for the substrate 505. The platen 508 comprises a base member 509 having a recess 526 configured to retain and support an electrode assembly 510 and the polishing belt 506 therein. A plurality of contact elements 518 are generally disposed in a plurality of holes 519 formed in the base member 509. The plurality of contact elements 518 are generally positioned at the same level or slightly above the upper surface 512 of the polishing belt 506.

A power supply 525 is adapted between the plurality of contact elements 518 and the electrode assembly 510 to provide a polishing bias during an electrochemical mechanical polishing process. During process, the substrate 505 is in contact with the plurality of contact element 518 to be biased.

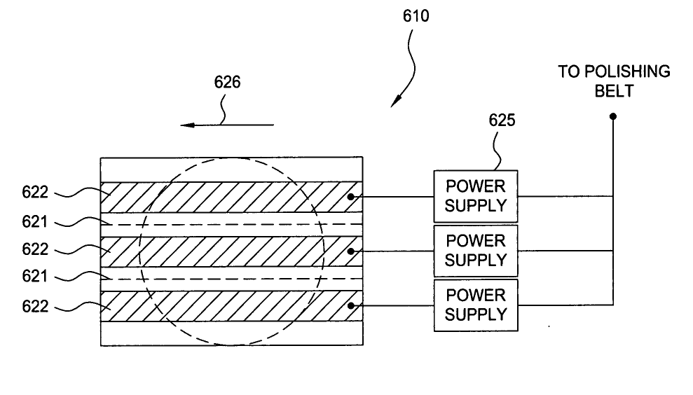

FIG. 6 illustrates a top view of a zoned electrode assembly 610 which may be advantageously adapted for use with various embodiments of the invention described herein. In one embodiment, the zoned electrode assembly 610 has a rectangular shape with one set of the edges parallel to the direction 626 of linear movement of a polishing belt. The zoned electrode assembly 610 generally comprises at least one dielectric spacer 621 and at least two conductive elements 622. The conductive elements 622 are arranged to create a plurality of independently biasable zones across the zoned electrode assembly 610. Each of the conductive elements 622 is independently connected to a power supply 625 and independently controllable to achieve desirable polishing profile across a substrate. It should be noted that the zoned electrode assembly may be configured differently to suit a particular polishing application.

While the foregoing is directed to embodiments of the present invention, other and further embodiments of the invention may be devised without departing from the basic scope thereof, and the scope thereof is determined by the claims that follow.

1. An apparatus for electro-chemical mechanical polishing a conductive surface on a substrate, comprising:
a fluid basin having a fluid volume for retaining a polishing solution;
a linear polishing station disposed in the fluid basin, wherein the linear polishing station having at least one electrode and a conductive top surface with a linear movement, the conductive top surface is configured to provide an electrical bias to the conductive surface on the substrate; and
a carrier head configured to retain the substrate and position the conductive surface of the substrate to be in contact with the conductive top surface of the linear polishing station.

2. The apparatus of claim 1, wherein the conductive top surface of the linear polishing station comprises a polishing belt looping around a pair of rollers configured to provide the linear movement, and the at least one electrode is supported by a platen disposed between the pair of rollers.

3. The apparatus of claim 2, wherein the polishing belt having an at least partially conductive polishing surface.

4. The apparatus of claim 3, wherein the polishing belt comprises an upper layer made of a conductive woven material.

5. The apparatus of claim 3, wherein the polishing belt comprises a conductive strip.

6. The apparatus of claim 2, wherein the conductive top surface further comprises a plurality of conductive elements protruding from the platen, and the polishing belt having a non-conductive polishing surface.

7. The apparatus of claim 2, further comprises a support portion disposed between the at least one electrode and the polishing belt.

8. The apparatus of claim 1, further comprises a solution supply inlet configured to supply the polishing solution to the conductive top surface.

9. An apparatus for electrochemical mechanical polishing a conductive surface of a semiconductor substrate, the apparatus comprises:
a fluid basin configured to retain a polishing solution;
a pair of rollers disposed in the fluid basin;
a polishing belt looping around the pair of rollers configured to drive the polishing belt linearly;
at least one electrode supported by a platen disposed between the pair of rollers; and
a carrier head configured to retain the substrate and position the conductive surface of the substrate to be in contact with the polishing belt.

10. The apparatus of claim 9, wherein the polishing belt has an at least partially conductive upper surface configured to provide an electric bias to the substrate.

11. The apparatus of claim 10, wherein the polishing belt comprises an upper layer made of conductive woven material.

12. The apparatus of claim 10, wherein the polishing belt comprises one or more conductive strips.

13. The apparatus of claim 9, further comprising a plurality of conductive elements protruding from the platen, wherein the plurality of conductive elements are configured to provide an electrical bias to the conductive surface of the substrate.

14. The apparatus of claim 9, further comprises a solution supply inlet configured to supply the polishing solution to the polishing belt.

15. A method for electrochemical mechanical polishing a conductive surface on a substrate, comprising:
mounting a polishing belt on a pair of rollers disposed in a fluid basin containing a polishing solution;
wetting the polishing belt while moving the polishing belt linearly by rotating the pair of rollers; and
contacting the conductive surface on the substrate with the polishing belt to apply a first bias between the substrate and a first electrode supported by a platen disposed between the pair of rollers.

16. The method of claim 15, further comprising applying the first bias between a conductive element on the polishing belt and the first electrode.

17. The method of claim 16, wherein the conductive element is a conductive upper surface made from a conductive woven material.

18. The method of claim 16, wherein the conductive element is a conductive strip on the polishing belt.

19. The method of claim 15, further comprising applying the first bias between a plurality of conductive elements adjacent the polishing belt protruding from the platen and the first electrode.

20. The method of claim 15, further comprising applying a second bias between a second electrode supported by the platen and the substrate.
